(19) United States
(12) Patent Application Publication
(10) Pub. No.: US 2012/0134611 A1
(43) Pub. Date: May 31, 2012

(54) ARM BEARING FOR AN ARTICULATED ARM AWNING

(76) Inventor: Wolfgang Voss, Attendorn (DE)

(21) Appl. No.: 13/151,625

(22) Filed: Jun. 2, 2011

Related U.S. Application Data
(63) Continuation of application No. PCT/EP2009/008338, filed on Nov. 24, 2009.

(30) Foreign Application Priority Data
Dec. 4, 2008 (DE) 10 2008 062 654.6

(51) Int. Cl. F16C 23/00

(52) U.S. Cl. 384/247

(57) ABSTRACT

An arm bearing for an articulated arm awning comprises a bearing block which is fastened to a supporting block so as to be pivotable about a tilting axis and which, at one end, has at least one bearing eye for receiving a bearing axis of an awning arm in a manner rotatable about an axis of rotation, furthermore a tilting angle limiting element for limiting a tilting angle between the supporting block and the bearing block, wherein a first end of the tilting angle limiting element is connected to the supporting block, and a second end of the tilting angle limiting element is designed as a stop which interacts with a counterstop on the bearing block, and a locking slide which fixes the second end of the tilting angle limiting element and the counterstop on each other, wherein the locking slide is movable in a translatory manner by means of a rotational movement of the awning arm about the axis of rotation. The locking slide is in engagement with the bearing axis of the awning arm, at least in a predetermined angle of rotation range of the awning arm, a rotational movement of the bearing axis within the predetermined angle of rotation range being converted into a translatory movement of the locking slide.

### CROSS REFERENCE TO RELATED APPLICATIONS

This application is a continuation of international patent application PCT/EP2009/008338, filed on Nov. 24, 2009 and designating the U.S., which international patent application has been published in German language and claims priority from German patent application No. 10 2008 062 654.6 filed on Dec. 4, 2008. The entire contents of these priority applications are incorporated herein by reference.

### BACKGROUND OF THE INVENTION

The invention relates to an arm bearing for an articulated arm awning having a bearing block and a supporting block to which the bearing block is fastened such that the bearing block which carries the articulated arm of the awning can be tilted with respect to the supporting block.

An arm bearing of this type is also referred to as a tilting joint because of the pivotable connection between the bearing block and the supporting block. In the retracted state of the awning, i.e. when the awning canvas is wound up on the awning canvas shaft and, correspondingly, the articulated arm is rotated about an axis of rotation to such an extent that the articulated arm extends substantially parallel to the awning canvas shaft, the bearing block is in the position thereof pivoted upward or toward the awning canvas shaft. When the awning is extended, i.e. the awning canvas is unwound from the awning canvas shaft and the articulated arm is correspondingly rotated about the axis of rotation, the bearing block pivots downward until the tilting angle is reached, as a result of which the articulated arm and therefore the awning canvas are inclined in a desired manner with respect to the horizontal.

In order to limit the tilting of the bearing block, and therefore of the articulated arm, about the tilting axis, a tilting angle limiting element is provided. In the case of an arm bearing known from WO 01/27409 A1, the tilting angle limiting element is adjustable in order to be able to preset the tilting angle between the supporting block and the bearing block. In the known arm bearing, the tilting angle limiting element is designed as a threaded rod, one end of which is screwed adjustably into a receptacle in the supporting block and the second end of which has a head which is designed as a stop which interacts with a counterstop on the bearing block, the counterstop being formed by the edge of an opening of the bearing block, the opening cross section of which opening is smaller than the cross section of the head of the threaded rod.

In order, when the awning is extended, i.e. when the awning canvas is unwound, to prevent the bearing block from being able to pivot upward again and the articulated arm from accordingly being able to be blown upward, for example if a gust of wind reaches under the awning canvas, the locking slide is provided, said locking slide fixing the second end of the tilting angle limiting element and the counterstop on the bearing block on each other, at least if the bearing block is tilted in relation to the supporting block by the set tilting angle. The locking slide is moved in a translatory manner by means of a rotational movement of the awning arm about the axis of rotation and, as a result, brought into its locking position. In order for the locking slide to be effective in a locking manner as early as possible, i.e. even if only part of the canvas is unwound from the awning canvas shaft, the locking slide is already moved in a translatory manner during the initial rotational movement of the awning arm, in order to fix the second end of the tilting angle limiting element and the counterstop on each other.

In the known arm bearing, the locking slide is arranged on that side of the tilting angle limiting element which faces away from the axis of rotation of the awning arm and is connected via a connecting element to a connecting rod which runs parallel to the locking slide and, at one end, has an end surface which is in engagement with an awning arm end surface formed eccentrically with respect to the axis of rotation. Said eccentric end surface on the awning arm is formed on a fork limb of the awning arm, via which the awning arm is fastened rotatably to the bearing eye of the bearing block.

The U-shaped arrangement of the locking slide, connecting element and connecting rod gives rise to the following disadvantages. Firstly, the U-shaped arrangement of the locking slide, connecting element and connecting rod is complicated structurally. Secondly, said arrangement is sensitive to manufacturing tolerances. Since the locking slide and the connecting rod are guided in a manner substantially true to size in mutually parallel bores in the bearing block, the connecting rod and the locking slide likewise have to be oriented as exactly as possible parallel to each other. If the connecting rod and the locking slide are not oriented exactly parallel to each other, wedging may occur during the translatory movement of the locking slide. The connecting rod of the known arm bearing is pretensioned by a spring which is located between the two ends of the connecting rod, the spring being securable with a snap ring. Said snap ring is occasionally broken after a certain number of load changes.

### SUMMARY OF THE INVENTION

The invention is therefore based on the object of developing an arm bearing of the type mentioned at the beginning to the effect that the means of securing against blowing upward is less complicated structurally and is less susceptible to malfunction.

According to an aspect of the invention, an arm bearing for an articulated arm awning is provided, comprising a bearing block having at least one bearing eye for receiving a bearing axis of an awning arm, the bearing axis being rotatable about an axis of rotation, a supporting block to which the bearing block is fastened so as to be pivotable about a tilting axis, a tilting angle limiting element for limiting a tilting angle between the supporting block and the bearing block about the tilting axis, the tilting angle limiting element having a first end and a second end, the first end of the tilting angle limiting element being connected to the supporting block, and the second end of the tilting angle limiting element being designed as a stop, the bearing block having a counterstop, a locking slide which fixes the second end of the tilting angle limiting element and the counterstop on each other, the locking slide being movable in a translatory manner, the locking slide being in engagement with the bearing axis at least in an angle of rotation range of the bearing axis about the axis of rotation, a rotational movement of the bearing axis about the axis of rotation within the angle of rotation range being converted into a translatory movement of the locking slide.

Owing to the fact that, in the arm bearing according to the invention, the locking slide is in engagement with the bearing axis of the awning arm, in order to derive the translatory movement of the locking slide from a rotational movement of the bearing axis within a predetermined angle of rotation range of the bearing axis, the U-shaped arrangement of the locking slide, connecting element and connecting rod can be dispensed with in the arm bearing according to the invention. In other words, the connecting element and the connecting rod, which are provided in the known arm bearing in order to move the locking slide, can be omitted in the arm bearing according to the invention. The means of preventing the arm bearing according to the invention from being blown upward is therefore structurally substantially simpler. The arm bearing according to the invention is also less susceptible to malfunction because it no longer relies, as in the known arm bearing, on exact parallelism between the connecting rod and locking slide. In the case of the arm bearing according to the invention, only the locking slide still has to be guided in a single bore in the bearing block. The arm bearing according to the invention is therefore also less susceptible to manufacturing tolerances than the known arm bearing.

Since, in the case of the arm bearing according to the invention, the locking slide is in engagement with the bearing axis of the awning arm in order to produce the translatory movement of the locking slide, the external appearance of the arm bearing according to the invention is also improved. In the case of the known arm bearing, the connecting rod, as described above, is in engagement with an eccentrically formed end surface on a fork limb of the awning arm. Said region is visible during use of the awning. If the eccentric end surface is integrally formed on the fork limb, the connecting rod scratches the end surface of the fork limb of the awning arm during use, as a result of which the coat of paint on the end surface is damaged. In order to improve the appearance of the known arm bearing, a special steel fitting containing the eccentricity has therefore been attached to the fork limb. A metal fitting of this type can now likewise be omitted in the arm bearing according to the invention, and, as a result, the arm bearing according to the invention is also more universally usable because special arrangements do not have to be made on the awning arm itself. In the arm bearing according to the invention, the locking slide is in engagement with the bearing axis of the awning arm, which bearing axis is located in the bearing eye of the bearing block, with said point of engagement not being visible from the outside during use of the awning.

The locking slide of the arm bearing according to the invention can be in engagement in different ways with the bearing axis of the awning arm within the predetermined angle of rotation range of the awning arm. For example, a locking slide end side which extends transversely with respect to the longitudinal direction of the locking slide may be in engagement with a bearing axis surface contour which is formed eccentrically with respect to the axis of rotation.

However, in a preferred refinement, within the predetermined angle of rotation range, a first surface portion of a longitudinal side of the locking slide is in engagement with a second surface portion of the bearing axis.

The advantage here is that the bearing axis does not have to be provided with an outer contour which is eccentric with respect to the axis of rotation, this simplifying the production of the bearing axis as a customary turned part. In addition, the bearing eye in the bearing block for the mounting of the bearing axis can be produced to be continuously cylindrical with a cross section matched to the diameter of the bearing axis, this also simplifying the manufacturing of the bearing block.

In a further preferred refinement, the locking slide is in engagement within the predetermined angle of rotation range with the bearing axis in a form-fitting manner.

In comparison to a frictional engagement which is obtained, for example, by means of frictional force between the locking slide and the bearing axis, a form-fitting engagement has the advantage of being less susceptible to malfunction and of reducing wear phenomena. A form-fitting engagement can be realized, for example, by means of a toothing between the longitudinal side of the locking slide and the longitudinal side of the bearing axis.

However, a structurally very simple refinement is preferred, according to which the locking slide has a shoulder in the region of the first surface portion, where the bearing axis has a flattened portion in the region of the second surface portion.

This refinement of the engagement between the locking slide and the bearing axis is advantageously particularly simple structurally. By means of the flattened portion of the bearing axis, an edge is produced in the transition between the flattened portion and the round outer contour of the bearing axis, said edge engaging within the predetermined angle of rotation range at the shoulder on the locking slide in order to move the latter in a translatory manner such that said locking slide can be moved from the locking position thereof into the nonlocking position thereof, or vice versa.

With the exception of the flattened portion, the bearing axis can advantageously therefore be manufactured cylindrically and therefore as a simple turned part, and the locking slide can also be manufactured as a turned part, with the turning of a shoulder constituting a simple manufacturing step.

In a further preferred refinement, the locking slide extends from the bearing axis rectilinearly toward the second end of the tilting angle limiting element.

The locking slide extends here directly between the bearing axis and the tilting angle limiting element, thus enabling the arm bearing according to the invention to be constructed to be shorter in the direction of the tilting axis than the known arm bearing, in which the locking slide is arranged on that side of the tilting angle limiting element which faces away from the bearing axis and is in engagement with the awning arm via the connecting element and the connecting rod. The rectilinear configuration of the locking slide enables the locking slide itself to be manufactured particularly simply.

In a further preferred refinement, the locking slide is prestressed in the direction toward the second end of the tilting angle limiting element.

It is advantageous here that the configuration of the engagement region between the locking slide and the bearing axis can be further simplified because the bearing axis has to exert an entraining force on the locking slide only in a direction of the translatory movement of the locking slide. The locking slide here is preferably prestressed into the locking position thereof.

In a further preferred refinement, the locking slide is guided movably in a translatory manner in a bore in the bearing block.

It is advantageous here that the locking slide, owing to being guided in the bore, is protected from tilting and therefore from malfunctions, and, furthermore, in the finished arm bearing the locking slide cannot be seen from the outside, and therefore the appearance of the arm bearing is improved.

It is preferred here if a threaded pin is screwed in the bore to the bearing block, the locking slide being held movably in the bore relative to the threaded pin.

In conjunction with the abovementioned configuration of the prestressing of the locking slide, a compression spring is arranged between the threaded pin and the locking slide, the compression spring prestressing the locking slide into the locking position thereof. The locking slide is held loss-proof in the bore in the bearing block via the threaded pin.

Further advantages and features emerge from the description below and the attached drawing.

It goes without saying that the features mentioned above and those which have yet to be explained below can be used not only in the respectively stated combination but also in different combinations or on their own without departing from the scope of the present invention.

### BRIEF DESCRIPTION OF THE DRAWINGS

An exemplary embodiment of the invention is illustrated in the drawing and is described in more detail hereinbelow with respect thereto. In the drawing:

FIG. 1 shows a perspective side view of an arm bearing with a partially illustrated articulated arm fastened thereto, in a first operating position;

FIG. 2 shows the arm bearing in FIG. 1 in a section along the line II-II in FIG. 1;

FIG. 3 shows a perspective side view of the arm bearing in FIG. 1 in a further operating position; and

FIG. 4 shows a section along the line IV-IV in FIG. 3.

### DETAILED DESCRIPTION OF AN EXAMPLARY PREFERRED EMBODIMENT

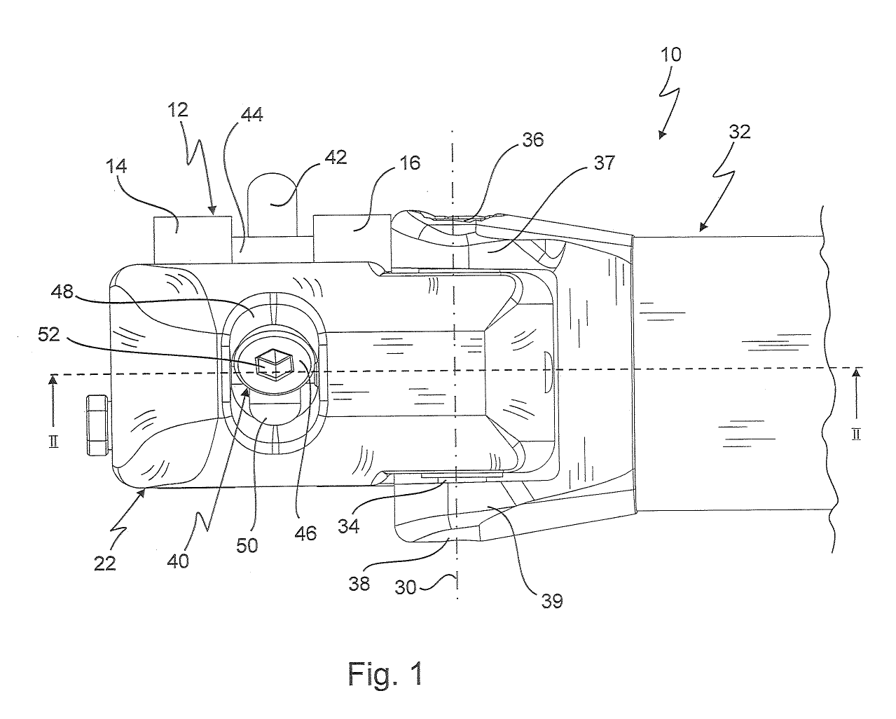

An arm bearing provided with the general reference number 10 is illustrated in FIGS. 1 to 4.

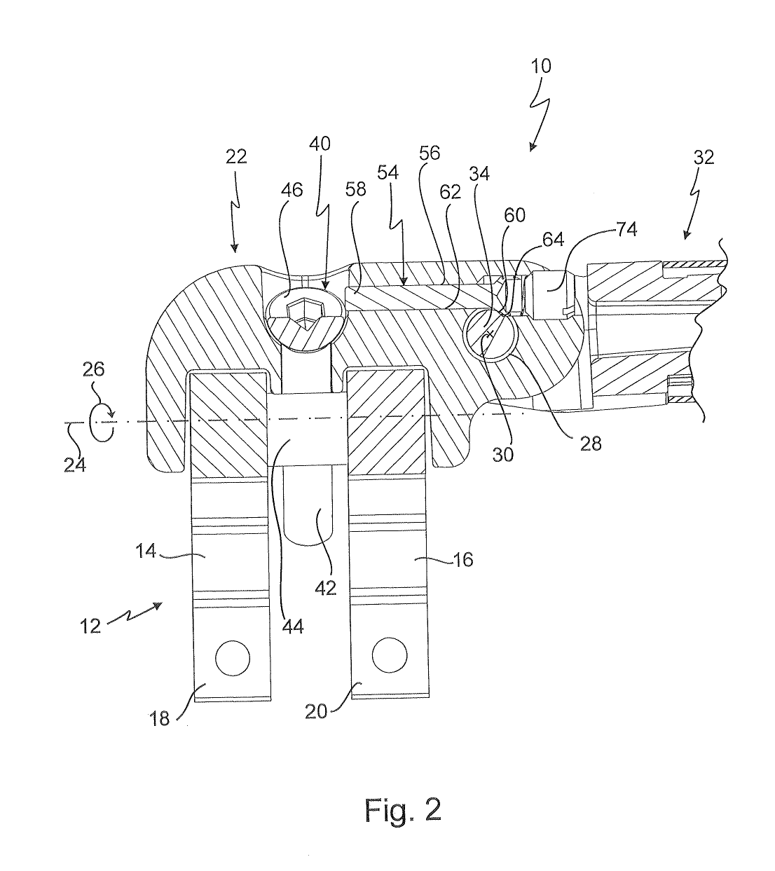

The arm bearing 10 has a supporting block 12 which, in the exemplary embodiment shown, has two limbs 14 and 16. Each limb 14 and 16 has a respective installation portion 18 and 20 (FIG. 2) for fastening the supporting block 12 and therefore the arm bearing 10 to a supporting tube (not illustrated) of an awning.

At the end opposite the installation portions 18, 20, a bearing block 22 is fastened to the supporting block 12. The bearing block 22 is fastened here to the supporting block 12 in such a manner that the bearing block 22 can be pivoted about a tilting axis 24 relative to the supporting block 12, as indicated by an arrow 26.

The bearing block 22 has a bearing eye 28 which serves for the articulation of an articulated arm 32 in a manner rotatable about an axis of rotation 30. The articulated arm 32 is only partially illustrated in FIGS. 1 to 4 in the region of the end thereof which is articulated on the arm bearing 10. The articulated arm 32 is fastened to the arm bearing 10 via a bearing axis 34 which is rotatable about the axis of rotation 30. The bearing axis 34 is designed here as a bolt which is plugged through an opening 36 on a fork limb 37 of the articulated arm 32, through the bearing eye 28 in the bearing block 22 and through an opening 38 in a further fork limb 39 of the articulated arm 32 and is secured in a suitable manner.

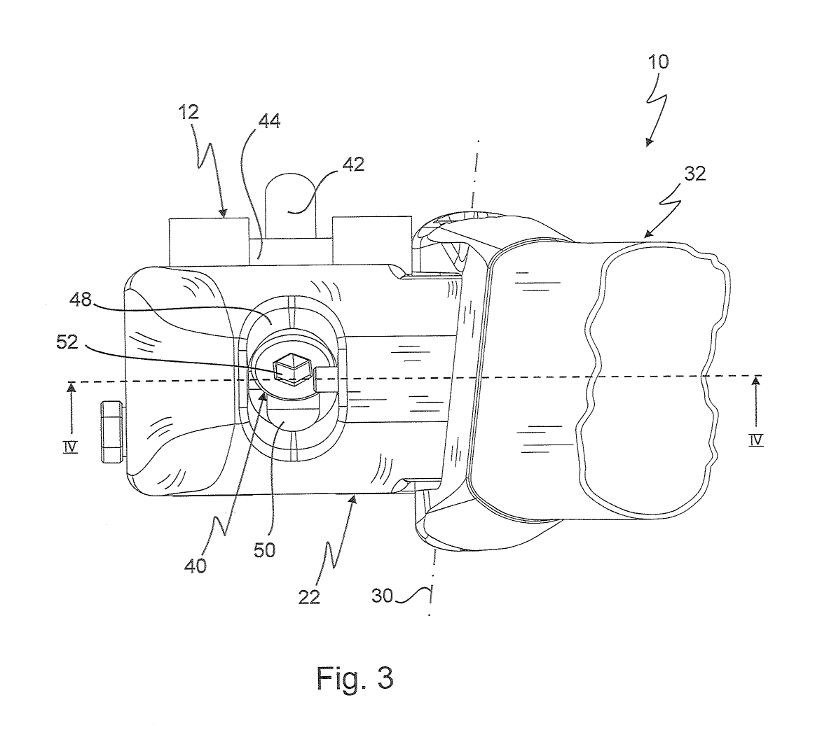

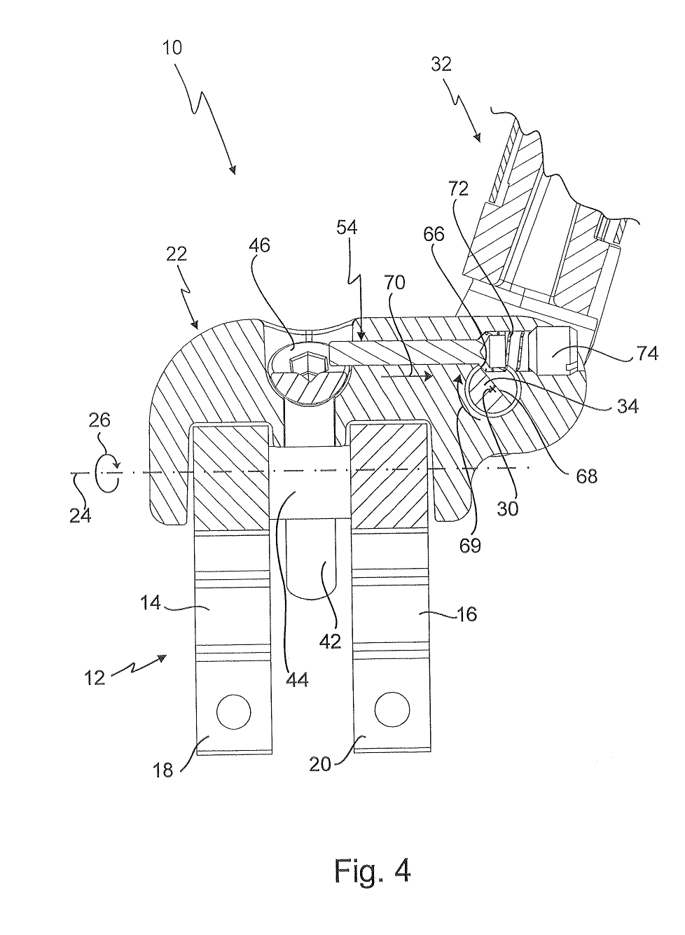

When the articulated arm 32 is rotated about the axis of rotation 30, the bearing axis 34 correspondingly rotates at the same time about the axis of rotation 30.

Whereas, in FIGS. 1 and 2, the articulated arm 32 is illustrated in the retracted position thereof, in which the articulated arm 32 extends substantially parallel to the tilting axis 24, the articulated arm 32 in FIGS. 3 and 4 is shown in a position rotated about the axis of rotation 30 and therefore extended, with the angle of rotation between the retracted position in FIG. 1 and the extended position in FIG. 3 being able to be approximately between 60° and 90°.

Upon extension of the articulated arm 32 from the position shown in FIGS. 1 and 2 into the position shown in FIGS. 3 and 4, the bearing block 22 tilts or pivots about the tilting axis 24 relative to the supporting block 12 (out of the plane of drawing in FIG. 1), said tilting movement being limited by a tilting angle limiting element 40.

The tilting angle limiting element 40 has a first end 42 which is connected to the supporting block 12. The end 42 is provided in particular with an external thread and is screwed into an internal thread in a central section 44 between the two limbs 14 and 16 of the supporting block 12. A second end 46 of the tilting angle limiting element 40 is designed as a stop which interacts with a counterstop 48 on the bearing block 22. The second end 46 of the tilting angle limiting element 40 is designed here as a screw head, and the counterstop 48 is formed by the rim of an opening 50 in the bearing block 22, the opening cross section of which opening is smaller than the maximum cross section of the second end 46 of the tilting angle limiting element 40.

In the exemplary embodiment shown, the tilting angle limiting element 40 is accordingly designed as a screw, the stem of which is inserted through the opening 50 in the bearing block 22 and is screwed to the supporting block 12.

The tilting angle limiting element 40 can be adjusted in order to set the maximum tilting angle, for which purpose, for example, a hexagon socket 52 for the insertion of a hexagon key is provided in the second end 46. By unscrewing the tiling angle limiting element 40, the maximum tilting angle is increased, and by screwing the tilting angle limiting element 40 into the supporting block 12, the maximum tilting angle is reduced.

Upon unwinding of the canvas (not illustrated) of the awning, to which the arm bearing 10 in addition to the articulated arm 32 is fitted, the articulated arm 32 extends from the position illustrated in FIGS. 1 and 2 to the position illustrated in FIGS. 3 and 4 by rotation about the axis of rotation 30, and even after a slight extension of the articulated arm 32, the bearing block 22 tilts or pivots downward about the tilting axis 24, said tilting movement being limited by the counterstop 48 striking against the second end 46 of the tilting angle limiting element 40.

The tilting angle of the bearing block 22 and therefore of the articulated arm 32 downward is adjustable within a range of between 0° (no tilting upon extension of the articulated arm 32) to approximately 60°. In the exemplary embodiment shown, the maximum tilting angle between the retracted position of the articulated arm 32 (illustrated in FIGS. 1 and 2) and the extended position of the articulated arm 32 according to FIGS. 3 and 4 is only a few degrees.

In particular if the maximum tilting angle is set to be large, care has to be taken to ensure that, in the event of, for example, a gust of wind reaching under the awning canvas, the articulated arm 32 is not blown upward. This is because, apart from when the tilting angle is set to 0°, the tilting angle limiting element 40 forms only a limit of the tilting of the bearing block 22 downward but does not prevent the latter from tilting back into the starting position. To this end, the arm bearing 10 has a means of preventing the articulated arm from being blown upward, said means having a locking slide 54 which is mounted movably in a translatory manner in a bore 56 in the bearing block 22. The locking slide 54 extends parallel to the tilting axis 24.

Whereas FIGS. 1 and 2 show the locking slide 54 in the nonlocking, pulled-back position thereof, FIGS. 3 and 4 show the locking slide 54 in the locking position thereof, in which an end 58 of the locking slide 54, which end faces the second end 46 of the tilting angle limiting element 40, comes to lie in front of the second end 46 of the tilting angle limiting element 40, as a result of which the bearing block 22 cannot pivot back from the tilted position into the untilted position.

Since the locking effect of the locking slide 54 is intended to be present only if a certain portion of the awning canvas has been unwound from the awning canvas shaft whereas the locking slide 54 is not intended to be effective in a locking manner if the awning canvas is wound up entirely onto the awning canvas shaft, or the articulated arm 32 is fully retracted, the effect of the locking slide 54 is dependent on the angle of rotation of the articulated arm 32 about the axis of rotation 30. This dependency of the position of the locking slide 54 on the rotational position of the articulated arm 32 about the axis of rotation 30 is used to derive the translatory movement of the locking slide 54 from the rotational movement of the articulated arm 32 about the axis of rotation 30.

In the arm bearing 10, the translatory movement of the locking slide 54 is derived from the rotational movement of the articulated arm 32 about the axis of rotation 30 by the locking slide 54 being in engagement with the bearing axis 34, at least within a predetermined angle of rotation range of the awning arm 32, a rotational movement of the bearing axis 34 within the predetermined angle of rotation range being converted into a translatory movement of the locking slide 54.

A surface portion 60 of the locking slide 54 on one longitudinal side 62 of the locking slide 54, which surface portion is level with the bearing eye 28 of the bearing block 22, is in engagement here with a surface portion 64 of the bearing axis 34. Said engagement is form-fitting within the predetermined angle of rotation range.

For this purpose, the locking slide 54 has, in the region of the surface portion 60, a shoulder or step 66 (FIG. 4), and the bearing axis 34 has a flattened portion 68, which is preferably limited in the direction of the bearing axis 34, in the region of the second surface portion 64, as a result of which the flattened portion 68 is in engagement with the shoulder 66, as emerges in particular from FIG. 4.

Starting from FIG. 4, in which the articulated arm 32 is extended, upon retraction of the articulated arm 32 and upon the corresponding rotation of the articulated arm 32 and the bearing axis 34 as per an arrow 69, the locking slide 54 is pulled back by the flattened portion 68 bearing against the shoulder or step 66, as indicated in FIG. 4 by an arrow 70. Upon retraction of the articulated arm 32, the locking slide 54 is correspondingly pulled back from the locking position thereof as per FIG. 4 into the nonlocking position as per FIGS. 1 and 2.

The locking slide 54 extends between the second end 46 of the tilting angle limiting element 40 and the bearing axis 34 and is in particular of rectilinear design. The rectilinear configuration of the locking slide 54 is made possible by the locking slide 54 being in engagement with the bearing axis 34 itself in order to derive the translatory movement from the rotational movement of the awning arm 32, and therefore, for the position of the locking slide 54 on the bearing block 22, a position can be found between the two fork limbs 37 and 39 of the articulated arm 32, which position is level with the second end 46 of the tilting angle limiting element 40. Angled or in particular U-shaped configurations of the locking slide 54 can therefore advantageously be avoided.

The locking slide 54 is prestressed into the locking position as per FIGS. 3 and 4 by means of a spring 72, here a compression spring. The spring 72 is located between a threaded pin 74 screwed into the outer end of the bore 56, and is supported against the locking slide 54, as a result of which the locking slide 54 is prestressed into the locking position.

The predetermined angle of rotation range of the bearing axis 34 and of the articulated arm 32, within which the locking slide 54 is in engagement with the bearing axis 34, is preferably limited to the angle of rotation range between the fully retracted position of the articulated arm 32 according to FIG. 1 and a slightly extended position of the articulated arm 32 such that the locking slide 54 is already effective in a locking manner when just a small amount of awning canvas is unwound from the awning canvas shaft.

If the arm bearing 10 is not intended to be operated as a tilting joint but rather as a rigid arm bearing with a rigid extension angle of the articulated arm 32 with respect to the horizontal, the locking slide 54 which is movable in a translatory manner can be replaced by an immovable locking pin which then always fixes the second end 46 and the counterstop 48 on each other such that, even when the articulated arm 32 is fully retracted, the set extension angle of the articulated arm 32 with respect to the horizontal is maintained. Since the threaded pin 74 is easily accessible, for example for a screwdriver, replacement of the translatory locking slide 54 for an immovable pin is easily possible.

What is claimed is:

1. An arm bearing for an articulated arm awning, comprising
a bearing block having at least one bearing eye for receiving a bearing axis of an awning arm, the bearing axis being rotatable about an axis of rotation,
a supporting block to which the bearing block is fastened so as to be pivotable about a tilting axis,
a tilting angle limiting element for limiting a tilting angle between the supporting block and the bearing block about the tilting axis, the tilting angle limiting element having a first end and a second end,
the first end of the tilting angle limiting element being connected to the supporting block, and the second end of the tilting angle limiting element being designed as a stop,
the bearing block having a counterstop,
a locking slide which fixes the second end of the tilting angle limiting element and the counterstop on each other, the locking slide being movable in a translatory manner, the locking slide being in engagement with the bearing axis at least in an angle of rotation range of the bearing axis about the axis of rotation, a rotational movement of the bearing axis about the axis of rotation within the angle of rotation range being converted into a translatory movement of the locking slide.

2. The arm bearing of claim 1, wherein, within the angle of rotation range, a first surface portion of a longitudinal side of the locking slide is in engagement with a second surface portion of the bearing axis.

3. The arm bearing of claim 1, wherein the locking slide is in engagement within the angle of rotation range with the bearing axis in a form-fitting manner.

4. The arm bearing of claim 2, wherein the locking slide has a shoulder in the region of the first surface portion.

5. The arm bearing of claim 2, wherein the bearing axis has a flattened portion in the region of the second surface portion.

6. The arm bearing of claim 1, wherein the locking slide extends from the bearing axis rectilinearly toward the second end of the tilting angle limiting element.

7. The arm bearing of claim 1, wherein the locking slide is prestressed in the direction toward the second end of the tilting angle limiting element.

8. The arm bearing of claim 1, wherein the locking slide is guided movably in a translatory manner in a bore in the bearing block.

9. The arm bearing of claim 8, wherein a threaded pin is screwed in the bore to the bearing block, the locking slide being held movably in the bore relative to the threaded pin.
